(19) United States
(12) Patent Application Publication
(10) Pub. No.: US 2006/0248374 A1
(43) Pub. Date: Nov. 2, 2006

(54) Packet Processing Switch and Methods of Operation Thereof

(76) Inventors: A. David S. MacAdam, Atlanta, GA (US); Jakob Saxtorph, San Jose, CA (US)

Correspondence Address: MYERS BIGEL SIBLEY & SAJOVEC, PO BOX 37428, RALEIGH, NC, 27627, US

(21) Appl. No.: 11/279,288

(22) Filed: Apr. 11, 2006

Related U.S. Application Data
(63) Continuation-in-part of application No. 11/395,575, filed on Mar. 31, 2006.
(63) Continuation-in-part of application No. 11/394,886, filed on Mar. 31, 2006.
(63) Continuation-in-part of application No. 11/395,570, filed on Mar. 31, 2006.
(60) Provisional application No. 60/672,349, filed on Apr. 18, 2005.

(51) Int. Cl. G06F 11/00

(52) U.S. Cl. 714/4

(57) ABSTRACT

A packet processing integrated circuit chip includes a plurality of input ports configured to receive packets from respective external sources and a plurality of output ports configured to transmit packets to respective external recipients. The chip further includes a packet processor configurable to process the received packets to generate new output packets with new payloads according to selected ones of a plurality of packet processing scenarios and to convey the new output packets to the output ports. Timing of each packet processing scenario is controlled responsive to received packet accumulation for the packet processing scenario. The chip may further include a packet switching fabric configured to route selected packets from the input ports to selected ones of the output ports without payload modification.

### CROSS-REFERENCE TO RELATED APPLICATIONS

The present application claims the benefit of United States Provisional Application Ser. No. Ser. No. 60/672,349, filed Apr. 18, 2005, the disclosure of which is hereby incorporated by reference herein in its entirety. This application also claims priority to and is a continuation-in-part of U.S. application Ser. Nos. 11/395,575; 11/394,886 and 11/395,570, all filed Mar. 31, 2006, the disclosures of which are hereby incorporated herein by reference

### BACKGROUND OF THE INVENTION

This invention relates to packet communications devices and methods and, more particularly, to packet switching devices and methods.

Increasing demand for communications services have generally increased bandwidth requirements for network components. For example, the increased volume of wireless communications has been generally accompanied by an increase in the bandwidth requirements between wireless terminals and base stations. Users demanding more information and more services from their cell phones and other wireless devices can overwhelm available bandwidth. Wireless service providers are migrating to 2.5 G and 3 G technologies to mitigate this problem. These technologies generally enable more data per broadcast band than 2 G technologies, which can be used to give more bandwidth to individual users or to serve more users in the same cell area.

An important aspect of 3 G wireless communications systems is closed loop power control. For example, in wideband code division multiple access (WCDMA) systems, it is typically desirable that a base station be capable of telling a mobile terminal to adjust its transmission power within 5 milliseconds after receiving a packet from the terminal. This can be the most constraining limitation on total delay in the base station, as it includes the round-trip delay of received radio signal sample going from an RF card, to a baseband card, and on to a control card, and back to the baseband card, RF card, and antenna. Each base station may have several RE and baseband cards, and signal samples may be transferred between any given RF card and any given baseband card. Reducing latency in transferring data between these cards tends to be important.

Different architectures may be used to convey data between such cards. In a fill-mesh architecture, each RE card is connected to each baseband card. A switched architecture provides a multiple-input multiple-output switch between the RE and baseband cards. The switched architecture can provide improved scalability and flexibility, but may add more latency than the full-mesh solution. Also, for smaller systems, a full-mesh architecture may be less expensive than a switched architecture.

Integrated circuits (ICs) have been developed that can support communications between base station components, such as RE cards and baseband cards. For example, Spectrum Signal Processing Inc. offers the ASIC-based Solano™ chip that can be used to interface processors, such as digital signal processors (DSPs), RISC processors, and FPGAs, and sources of data, such as RF cards. The chip includes eight high-speed FIFOs, with associated control logic, that are paired to form four fill-duplex channels. Tundra Semiconductor Corporation offers Serial RapidIO® chips that include a switching fabric that can be used to provide a switched architecture between RF and baseband cards.

### SUMMARY OF THE INVENTION

In some embodiments of the present invention, a packet processing integrated circuit chip includes a plurality of input ports configured to receive packets from respective external sources and a plurality of output ports configured to transmit packets to respective external recipients. The chip further includes a packet processor configurable to process the received packets to generate new output packets with new payloads according to selected ones of a plurality of packet processing scenarios and to convey the new output packets to the output ports. Timing of each packet processing scenario is controlled responsive to received packet accumulation for the packet processing scenario.

The packet processor may be configured to initiate packet accumulation for a packet processing scenario responsive to an initialization signal. A packet processing scenario of the plurality of packet processing scenarios may include a set of accumulation, processing and transmission operations required to generate a given number of new output packets from a given number of received packets, and the packet processor may be configured to iteratively execute the packet processing scenario responsive to received packet accumulation therefor. An iteration of the packet processing scenario may include processing of payloads of received packets for the packet processing scenario responsive to accumulation and/or generation of the given number of received packet payloads required to generate the given number of new output packets. The packet processing scenario may replace a payload of any packet addressed to the packet processing scenario that commences accumulating outside of a packet accumulation window defined by accumulation of a first accumulating received packet with a default packet payload.

In further embodiments, the packet processor may be configurable to extract data from payloads of the received packets and to process the extracted data to produce the new packets with the new payloads having formats compatible with data structures of the external recipients, e.g., data structures used by processors of the external recipients. For example, the packet processor may be configurable to perform bit extension, bit truncation, bit reordering and/or bit arithmetic operations on the received packets. The chip may further include a packet switching fabric configured to route selected packets from the input ports to selected ones of the output ports without payload modification.

In further embodiments of the invention, the packet processor may selectively apply the packet processing scenarios based on destination addresses in the packets. The plurality of packet processing scenarios may include individual packet processing scenarios and group packet processing scenarios that invoke concurrent processing by selected ones of the individual packet processing scenarios. The packet processing scenarios may be user-configurable.

According to further embodiments of the present invention, an interface circuit for conveying data between a first plurality of circuit cards and a second plurality of circuit cards includes a plurality of input ports configured to receive packets from respective ones of the first plurality of circuit cards and a plurality of output ports configured to transmit packets to respective ones of the second plurality of circuit cards. For example, the plurality of input ports may be configured to receive packets from respective ones of a plurality of RF cards and the plurality of output ports may be configured to transmit packets to respective ones of a plurality of baseband cards. The interface circuit further includes a packet processor configurable to process the received packets to generate new output packets with new payloads according to selected ones of a plurality of packet processing scenarios and to convey the new output packets to the output ports. Timing of each packet processing scenario is controlled responsive to received packet accumulation for the packet processing scenario. The interface circuit may further include a packet switching fabric configured to route selected packets from the input ports to selected ones of the output ports without payload modification.

### BRIEF DESCRIPTION OF THE DRAWINGS

FIG. 1 is a schematic diagram illustrating a packet processing switch integrated circuit chip according to some embodiments of the present invention.

FIG. 2 is a schematic diagram illustrating a packet processing switch integrated circuit chip according to further embodiments of the present invention.

FIGS. 3 and 4 illustrate exemplary port configurations for a packet processing switch according to some embodiments of the present invention.

FIG. 5 illustrates an exemplary packet flow architecture for a packet processing switch according to some embodiments of the present invention.

FIGS. 6 and 7 illustrate using packet destination addresses to route packets in a packet processing switch according to further embodiments of the present invention.

FIG. 8 illustrates an exemplary packet processing scenario structure according to some embodiments of the present invention.

FIG. 9 and 10 illustrate exemplary packet payload formats that may be used with some embodiments of the present invention.

FIG. 11 illustrates exemplary channel queues of a packet processor according to further embodiments of the present invention.

FIGS. 12 and 13 illustrate exemplary summing operations of a packet processor according to some embodiments of the present invention.

FIG. 14 illustrates an exemplary packet processing switch interface circuit application according to further embodiments of the present invention.

FIG. 15 illustrates exemplary packet structures for source cards of the application illustrated in FIG. 14.

FIG. 16 illustrates exemplary sample queues formed from the packets illustrated in FIG. 15.

FIGS. 17-20 illustrate exemplary output packets produced from the packets of FIG. 15 by various packet processing scenarios according to various embodiments of the present invention.

FIG. 21 illustrates exemplary operations of a packet processor according to some embodiments of the present invention.

FIGS. 22 and 23 illustrate exemplary packet processing initialization operations according to further embodiments of the present invention.

FIGS. 24-27 illustrate exemplary timing relationships for packet processing scenarios according to some embodiments of the present invention.

FIGS. 28 and 29 illustrate packet processors and exemplary operations thereof according to further embodiments of the present invention.

FIG. 30 illustrates exemplary operations for packet processing according to additional embodiments of the present invention.

### DETAILED DESCRIPTION OF EXEMPLARY EMBODIMENTS

Specific exemplary embodiments of the invention now will be described with reference to the accompanying drawings. This invention may, however, be embodied in many different forms and should not be construed as limited to the embodiments set forth herein; rather, these embodiments are provided so that this disclosure will be thorough and complete, and will filly convey the scope of the invention to those skilled in the art. In the drawings, like numbers refer to like elements. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

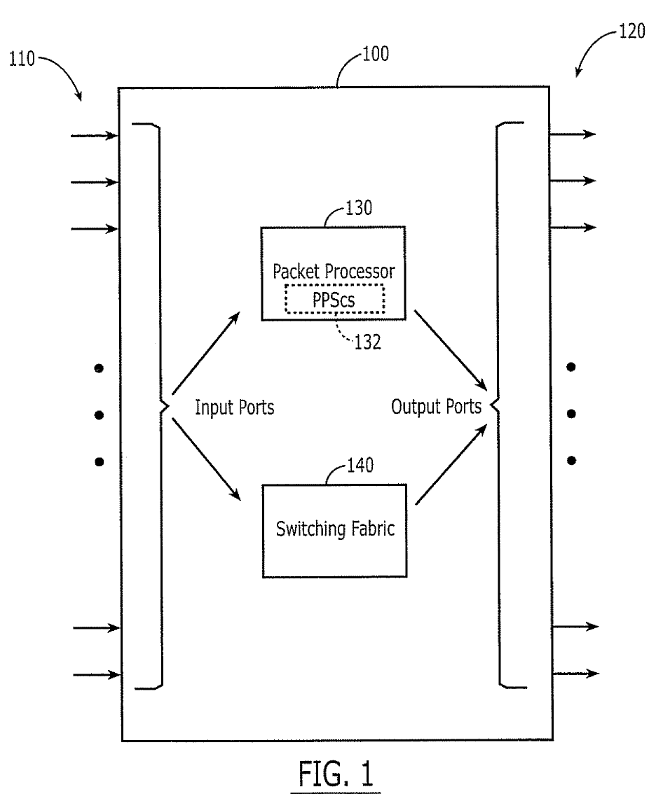

FIG. 1 illustrates a packet-processing switch integrated circuit (IC) chip 100 according to some embodiments of the present invention. The chip 100 includes input ports 110 that are configured to receive data packets. Packets received at the input ports 110 are selectively routed to a packet processor 130 or a switching fabric 140. The switching fabric 140 provides for routing of the received packets to output ports 120 of the chip 100 without payload modification.

The packet processor 130 synthesizes new packets with new payloads from selected packets received at the input ports 110 according to selected packet processing scenarios (PPScs) 132, with the synthesized packets being transmitted to external recipient devices via the output ports 120. As explained in detail below, the packet processing scenarios 132 may include various payload manipulations, such as bit extension, bit truncation, bit reordering (e.g., interleaving and/or flipping), and combining (e.g., summing or other arithmetic operations) of payloads from multiple received packets. Thus, for example, when used in a signal sample processing application such as in a wireless base station, the chip 100 can relieve the external recipient, e.g., a digital signal processor (DSP) or chip rate processor (CRP), of the burden of reformatting, a received signal sample stream for downstream operations, such as baseband processing. In addition, the packet processing scenarios 132 may be user-configurable, allowing the chip to be used for a variety of different communications protocols and/or messaging formats.

In various embodiments of the present described herein, a packet processing chip, such as the chip 100 illustrated in FIG. 1, may be configured to provide packet communications compliant with the RapidIO™ interconnect architecture, which includes physical and logical communications specifications for inter-device communications, as generally described at www.rapidio.org. It will be appreciated however, that although the exemplary embodiments described herein relate to RapidIO™-compliant packet processing switch chips and operations thereof, the present invention may use other packet communication architectures.

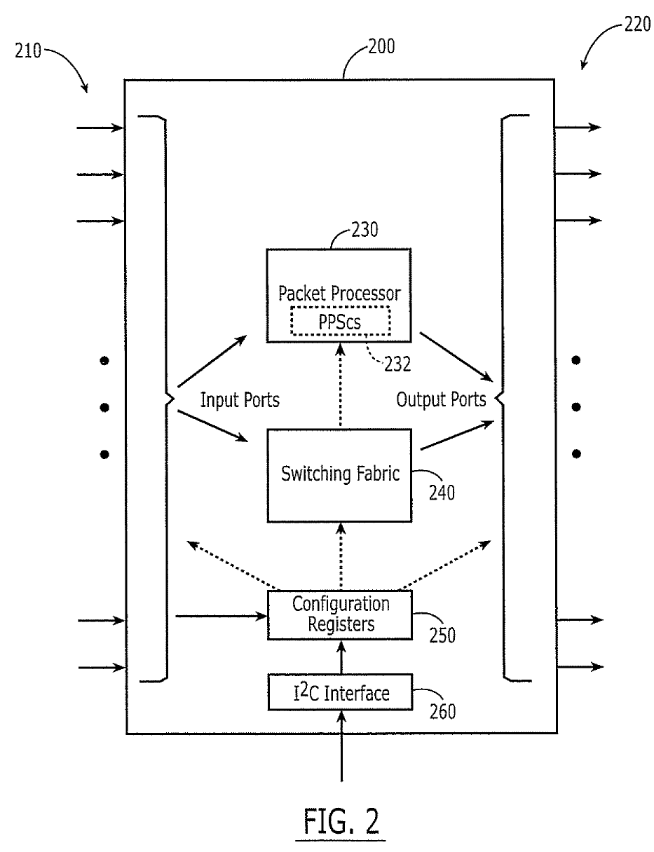

As shown in FIG. 2, a packet processing switch IC chip 200 according to further embodiments of the present invention may be user-configurable to provide various port configurations, packet processing scenarios, and/or switching functions defined in, for example, configuration registers 250. The configuration registers 250 may, for example, store parameters for packet processing scenarios 232 implemented by a packet processor 230, parameters for operations of a switching fabric 240 and/or parameters for configuration of input and output ports 210, 220. As shown, the configuration registers 250 may be configured via one of the input ports 210 and/or via an inter-integrated circuit (I²C) bus interface 260.

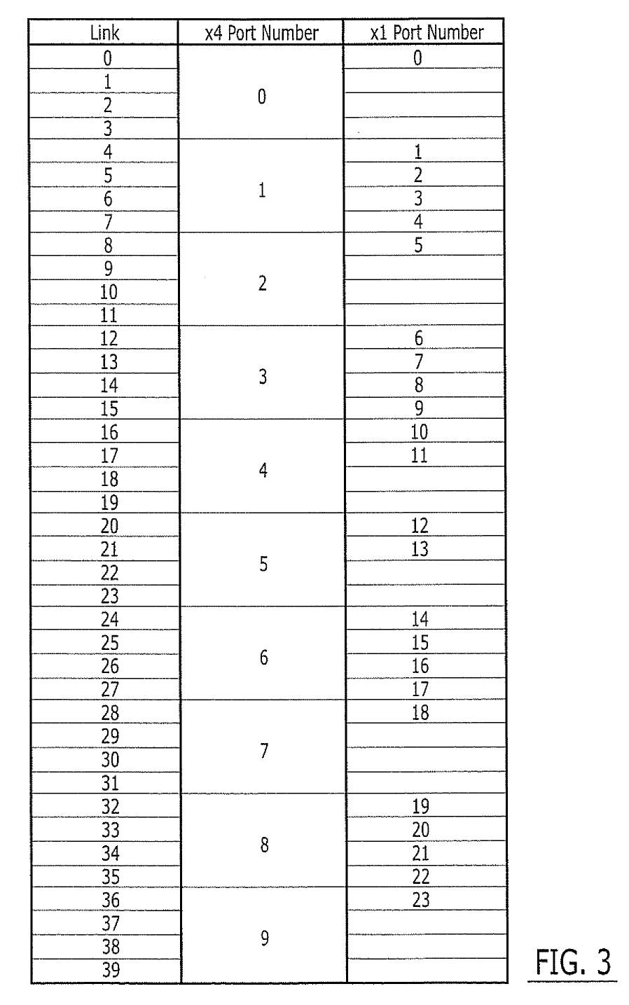

An example of an input/output port configurability scheme is illustrated in FIG. 3. In the illustrated example, 40 input/output links (lanes) may be programmable into 4x or 1x ports. Each link may, for example, be configured to handle long and short haul serial transmission as defined, for example, by the RapidIO™ serial specifications. Links 0-3 are programmable into one 4x or one 1x port, Links 4-7 are programmable into one 4x or four 1x ports, and Links 20-23 can be programmed as one 4x port. In the illustrated example, each link is a part of four-link group that is configured together, i.e., Link 3 is not configured with Links 4,5,6, and 7. The ports are numbered from Link 0 to Link 40 in ordered fashion. For example, if Links 0-3 are configured as a 4x port, they are assigned to be port 0; if links 4-7 are configured as individual 1x ports, they are assigned to port numbers 1 to 4. Table 1 illustrates some exemplary configurations:

TABLE 1

| | Number | Max | | |
|---|---|---|---|---|
| | of 4x | number of | Total Links | Total ports = |
| Configuration | ports (A) | 1x ports (B) | Used = 4A + B | A + B |
| 1 | 10 | — | 40 | 10 |
| 2 | 9 | 4 | 40 | 13 |
| 3 | 8 | 8 | 40 | 16 |
| 4 | 7 | 12 | 40 | 19 |
| 5 | 6 | 16 | 40 | 22 |
| 6 | 5 | 16 | 36 | 21 |
| 7 | 4 | 20 | 36 | 24 |
| 8 | 3 | 20 | 32 | 23 |
| 9 | 2 | 20 | 28 | 22 |
| 10 | 1 | 23 | 24 | 21 |
| 11 | — | 24 | 24 | 24 |

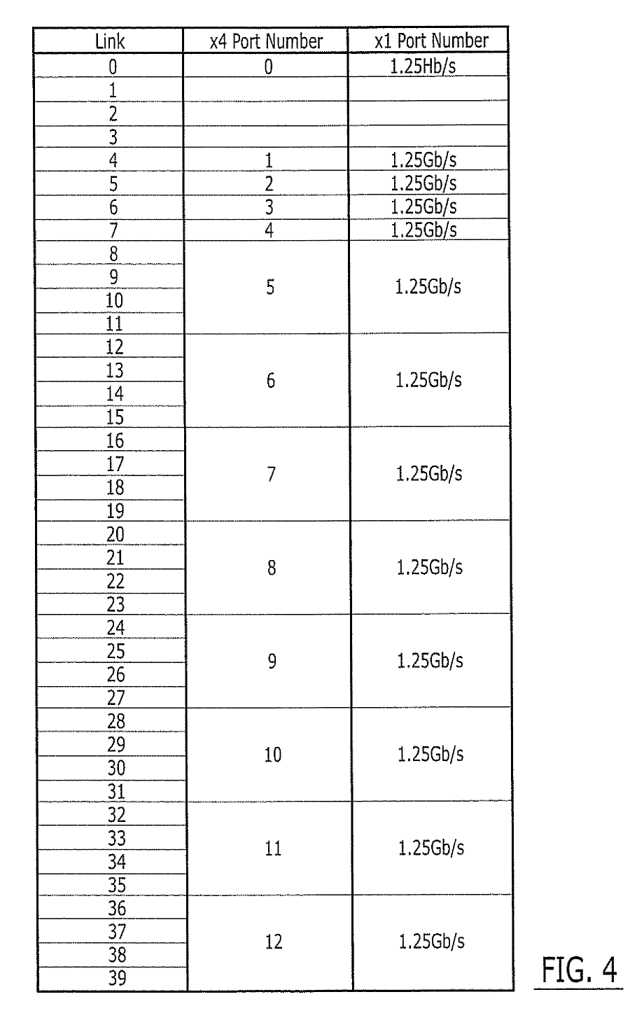

Referring again to FIG. 2, the configuration registers 250 may include registers to define port configuration, speed and/or timing (long run/short run), and other port characteristics. These registers can be programmed, for example, through the I²C bus interface 260 during an initialization procedure. In some embodiments, the I²C interface 260 may not be employed, and packets received via the input ports 210 may be used instead for device configuration. In such implementations, the input ports 210 may have a default (e.g., power-on) configuration to enable communication with the configuration source. This initial configuration does not have to be the end-desired configuration, but can allow communications to begin with the chip such that a desired configuration can be programmed. An exemplary power-on configuration is shown in FIG. 4, where Link 0 is set to be a 1x port 0 operating at 1.25 Gb/s, Links 4-7 are set to be 1x ports 1-4 operating at 1.25 Gb/s, and the remaining links are assigned to 4x, 1.25 Gb/s ports.

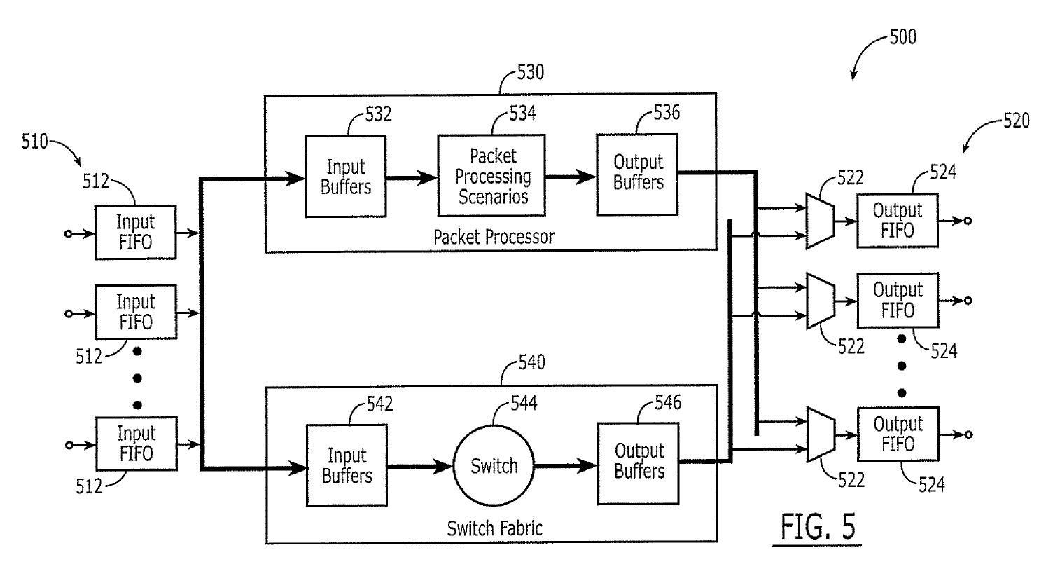

FIG. 5 illustrates exemplary packet flow architecture for a packet processing switch IC chip 500 according to further embodiments of the present invention. The chip 500 includes input ports 510 including input FIFOs 512 that receive packets from an external source. The received packets are transferred from the input FIFOs 512 to either a packet processor 530 or a switching fabric 540, for example, using destination addresses therein, as described in further detail below. The packet processor 530 and the switching fabric 540 respectively route synthesized packets or payload-unmodified packets to output ports 520, shown as including output FIFOs 524 and associated muxes 522.

Assuming, for purposes of the illustrated embodiments, that the received packets are RapidIO™ packets that include priority fields therein, the received packets intended for the switching fabric 540 may be stored in input buffers 542 based on the priority information in the received packets, and provided to a packet switch 544 according to the priority structure of the input buffers 542. Respective groups of the input buffers 542 are associated with respective ones of the input ports 510. The priority structure of each group of input buffers 542 may be user-configurable. For example, certain buffers may be assigned (e.g., using configuration registers) to receive packets having different ones of RapidIO™ priority levels 0-3. The switch 544 routes the packets from the input buffers 542 to various ones of a plurality of priority-structured groups of output buffers 546, with respective ones of the groups of output buffers 546 being associated with respective ones of the output ports 520.

In the packet processor 530, received packets to be processed in packet processing scenarios 534 are stored in input buffers 532. The packet processing scenarios 534 synthesize packets from the stored received packets. The synthesized packets are stored in output buffers 536, respective groups of which are associated with respective ones of the output ports 520. The synthesized packets may include priority information recovered from the received packets. The packets stored in the output buffers 536, 546 may be routed to the output ports 520 using, for example, round robin scheduling algorithms.

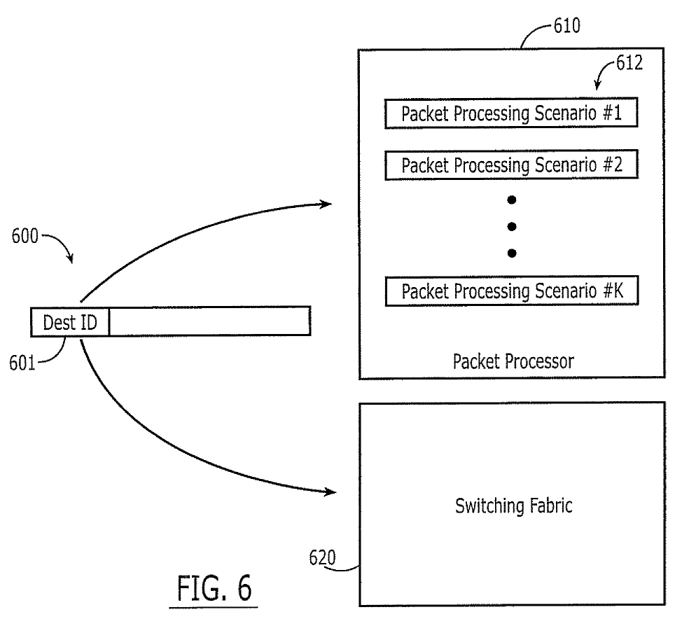

According to certain embodiments of the present invention illustrated in FIG. 6, routing of a received packet 600 to a packet processor 610 or a switching fabric 620 may be controlled based on a destination address 601 included in the received packet. In particular, respective destination addresses may be reserved for respective packet processing scenarios 612 supported by the packet processor 610, while other addresses are mapped to the switching fabric 620. Such an approach may be advantageous because it may be desirable that manipulation by the packet processor 610 be transparent to the sending and/or receiving device.

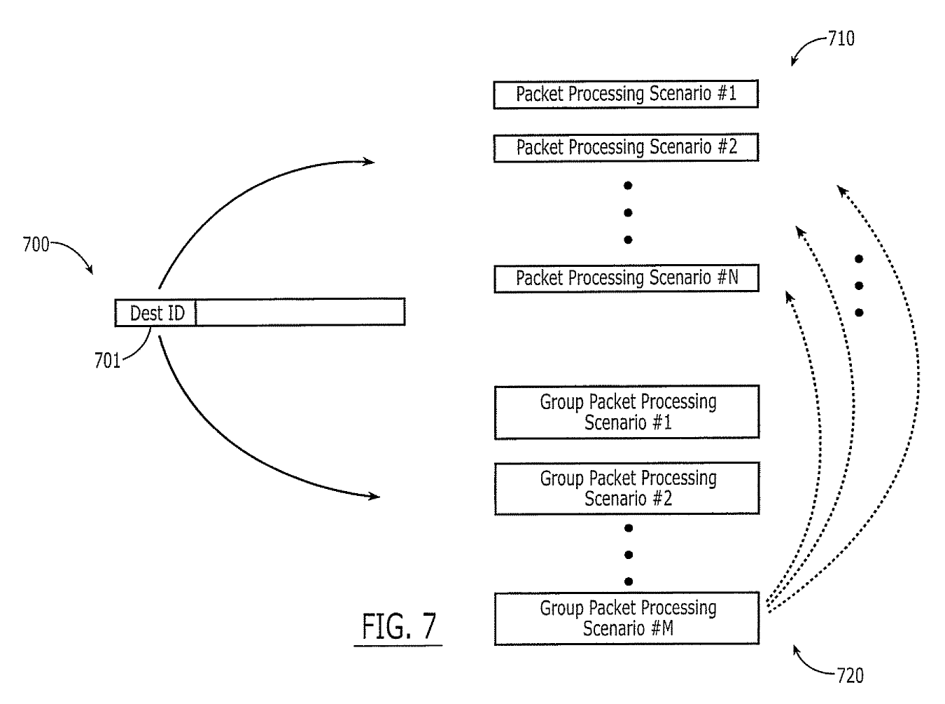

As shown in FIG. 7, packet processing scenarios implemented by a packet processor may include individual packet processing scenarios 710 and group packet processing scenarios 720. The individual packet processing scenarios 710 may be assigned to certain destination addresses 701 of input packets 700. The individual packet processing scenarios may be user configurable using, for example, configuration registers (e.g., the registers 250 of FIG. 2). Such configuration registers may, for example, define payload formats and operations performed on packet payloads for the particular packet processing scenarios. The group packet processing scenario addresses 720 may have other destination addresses 710 assigned thereto. As illustrated, the group packet processing scenarios 720 may be used to cause received packets to be multicast to groups of the individual packet processing scenarios 710 for parallel processing. Such groupings of individual packet processing scenarios may be configurable using, for example, configuration registers.

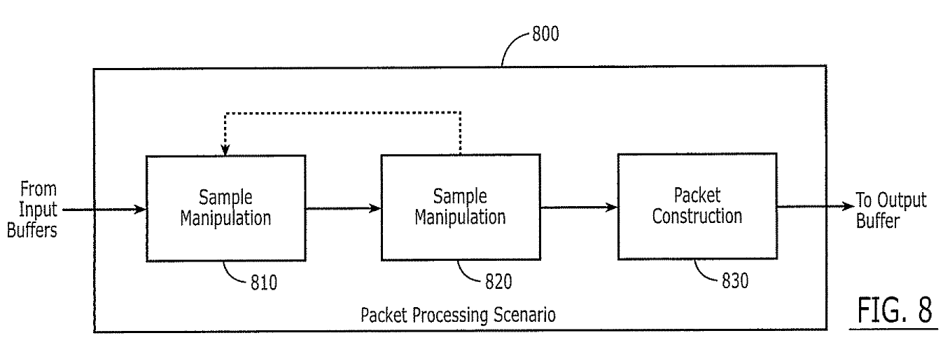

FIG. 8 illustrates an exemplary packet processing scenario 800 according to some embodiments of the present invention. The scenario 800 includes sample processing block 810, which may include, depending on the configuration of the scenario 800, initial sample and sub-sample level operations, such as increasing (padding) or decreasing the number of bits in a sample and/or flipping the order of bits and/or subsamples before queuing samples associated with separate channels (e.g., antennas) in separate queues in a queuing block 820. The queued samples may be further processed in the sample processing block 810 before transmission to a packet construction block 830, which creates new synthesized packets from the processed samples.

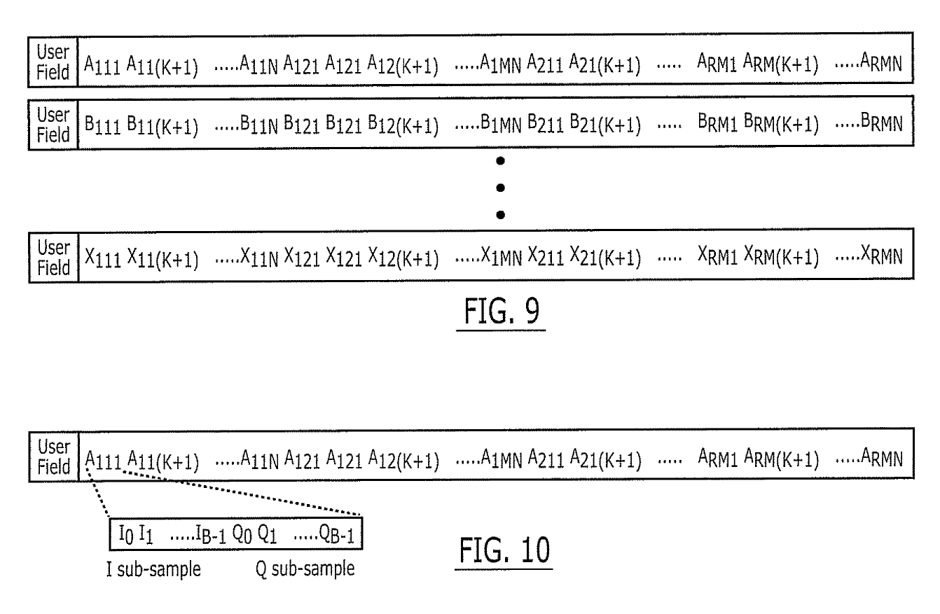

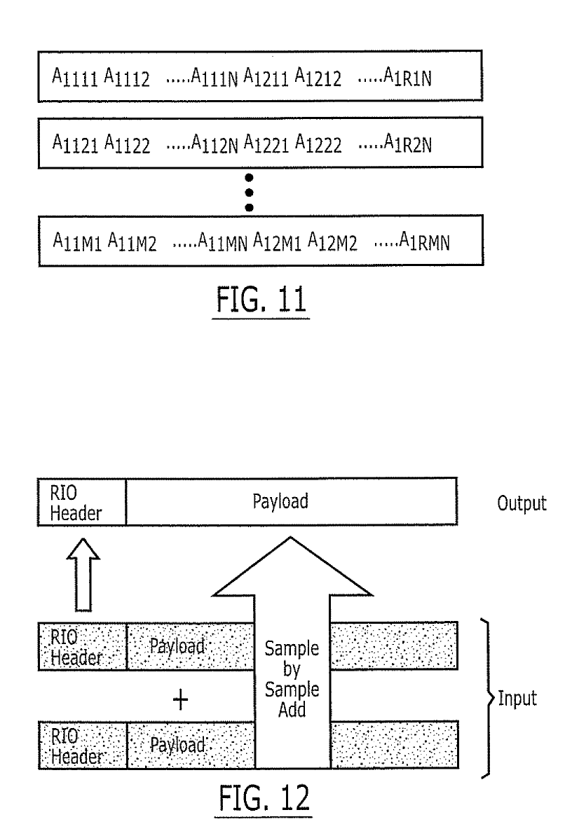

A packet processing scenario may receive, for example, packets corresponding to M channels, with N signal samples per channel and R repetitions of this structure in each packet. After termination of the packet overhead, packet payloads stored in the packet processor input buffers may look as illustrated in FIG. 9, where the payloads include reserved user fields (i.e., fields that are not processes) and signal samples A₁₁₁, . . . , A_{RMN}; B₁₁₁, B_{RMN}; . . . ; X₁₁₁, . . . , X_{RMN}. As shown in FIG. 10 each of the samples A₁₁₁, . . . , A_{RMN}, B₁₁₁, . . . , B_{RMN}, . . . , X₁₁₁, . . . , X_{RMN} may, in turn, include multiple sub-samples, for example, I and Q channel subsamples I₀, . . . , I_{B-1}, Q₀, . . . , Q_{B-1}. The sample format recognized by each packet processing scenario and/or the operations performed in each scenario may be register-configurable.

Beyond bit extension/truncation operations, the sample processing 810 may include reordering operations, such as rearranging the order of subsamples and/or the order of bits within samples. For example, assuming a sample is 4 bits I and 4-bits Q, the sample processing 810 may including flipping the I and Q subsamples individually as follows:
Input: I₀ I₁ I₂ I₃ Q₀ Q₁ Q₂ Q₃
Output: I₃ I₂ I₁ I₀ Q₃ Q₂ Q₁ Q₀

The sample processing 810 may also rearrange the order of subsamples in a sample as follows:
Input: I₀ I₁ I₂ I₃ Q₀ Q₁ Q₂ Q₃
Output: Q₀ Q₁ Q₂ Q₃ I₀ I₁ I₂ I₃

The sample processing 810 may also interleave I and Q bits as follows:
Input: I₀ I₁ , . . . I_{B-1} Q₀ Q₁ . . . Q_{B-1}
Output: I₀ Q₀I₁ Q₁ . . . I_{B-1} Q_{B-1}

These and other operations in the sample processing 810 may need to be performed in a particular order to maintain sample integrity. For example, assuming that input samples have an IQ format, are IQ interleaved, and each I and Q subsample has 6 bits, to produce an interleaved, IQ-flipped, sign-extended output, operations may need to be performed as follows:
Input: I₀ Q₀ I₁ Q₁ I₂ Q₂ I₃ Q₃ I₄ Q₄ I₅ Q₅;
Deinterleave I and Q: I₀ I₁ I₂ I₃ I₄ I₅ Q₀ Q₁ Q₂ Q₃ Q₄ Q₅;
Sign extend from LSB to 8 bits: I₀ I₁ I₂ I₃ I₄ I₅ I₅ I₅ Q₀ Q₁ Q₂ Q₃ Q₄ Q₅ Q₅ Q₅;
Flip: I₅ I₅ I₅ I₄ I₃ I₂ I₁ I₀ Q₅ Q₅ Q₅ Q₄ Q₃ Q₂ Q₁ Q₀;
Change IQ order: Q₅ Q₅ Q₅ Q₄ Q₃ Q₂ Q₁ Q₀ I₅ I₅ I₅ I₄ I₃ I₂ I₁ I₀; and
IQ Output Interleave: Q₅ I₅ Q₅ I₅ Q₅ I₅ Q₄ I₄ Q₃ I₃ Q₂ I₂ Q₁ I₁ Q₀ I₀.

As shown in FIG. 9, after initial processing, samples corresponding to respective ones of the M channels are placed in respective queues.

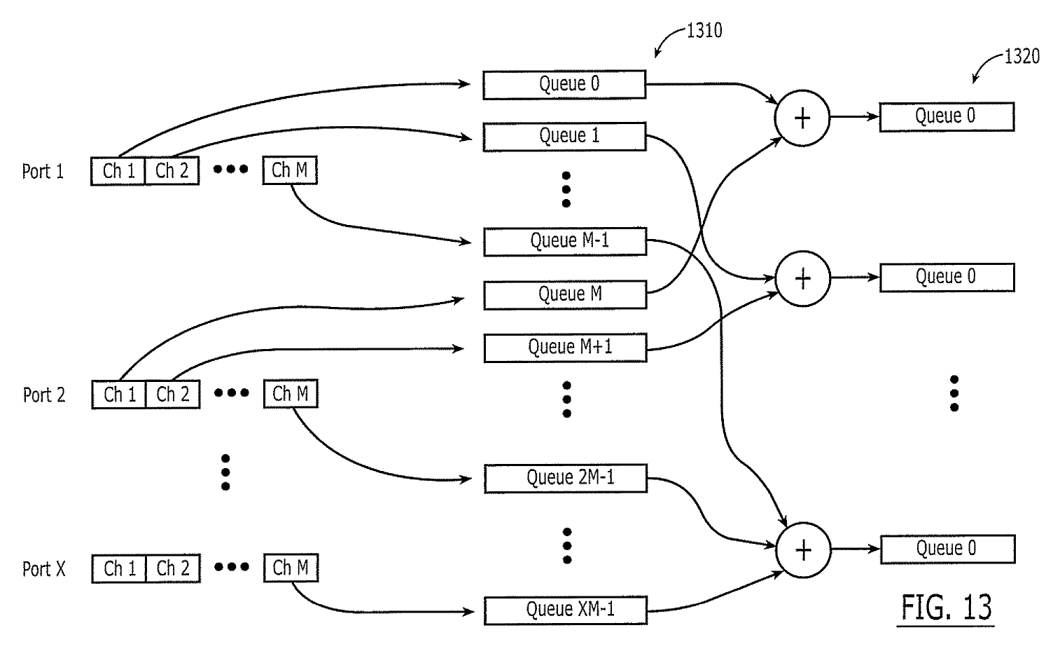

A given packet processing scenario also may be set up to provide for summing or other arithmetic operations on payloads from multiple packets, as illustrated in FIG. 12. In particular, as shown in FIG. 13, a new set of queues 1320 may be established to hold summation results from summing samples from multiple ports that are stored in other queues 1310. If summing is included in a particular scenario, certain bit manipulation operations of the sample processing, such as deinterleaving and bit extension or deletion, may have to be performed before summation, while other operations, such as flipping, I-Q ordering and interleaving, may need to be performed after summation.

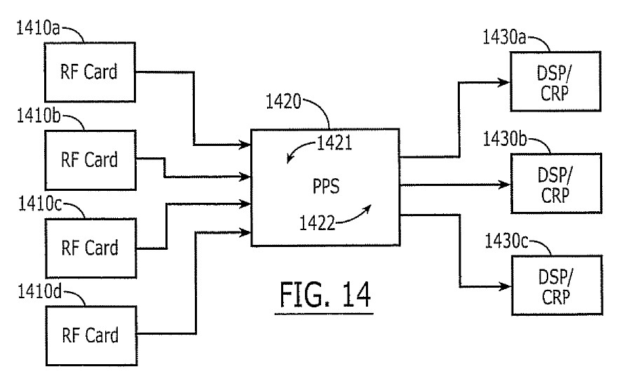

Exemplary use of a packet processing switch chip in a wireless base station environment according to some embodiments of the present invention will now be described with reference to FIGS. 14-20. It will be appreciated that these examples are offered for purposes of illustration, and that the present invention is not limited to the specific operations and architectures illustrated or, more generally, to application in wireless applications.

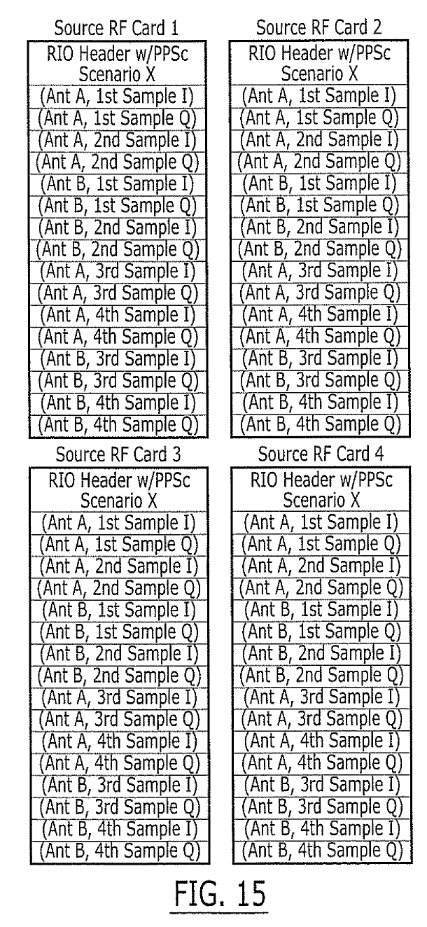

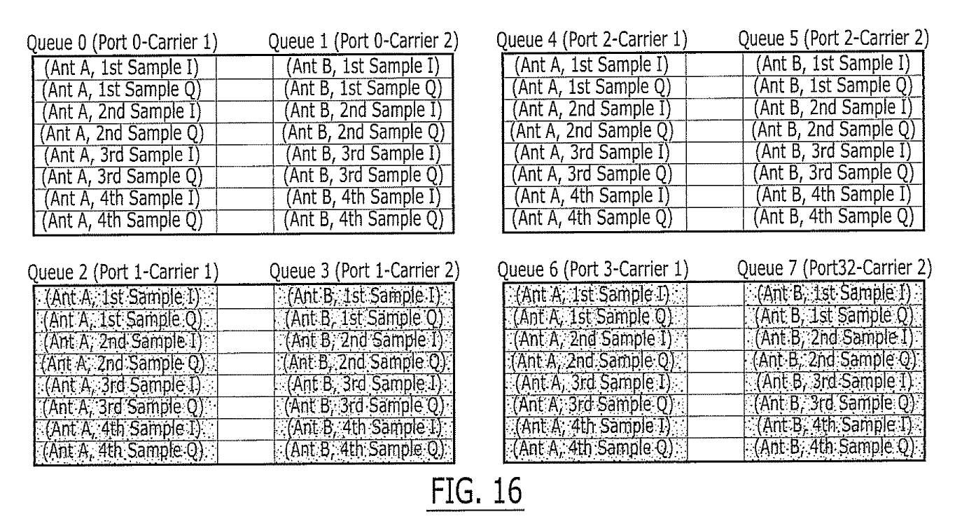

A typical wireless base station architecture is shown in FIG. 14, where four RF cards 1410a, 14110b, 1410c, 1410d provide packets containing radio signal samples to respective input ports 1421 of a packet processing switch (PPS) chip 1420. The chip 1420 processes payloads of the received packets, producing packets that are transmitted to respective digital signal processors/chip rate processors (DSPs/CRPs) 1430a, 1430b, 1430c via respective output ports 1422. It will be appreciated that the DSPs/CRPs 1430a, 1430b, 1430c may, for example, be configured to perform certain baseband processing functions, such as demodulation and decoding, on the signal samples produced by the RE cards 1410a, 1410b, 1410c, 1410d. For purposes of the following examples shown in FIGS. 15-20, each RE card 1410a, 1410b, 1410c, 1410d has 2 antenna channels, designated as Ant A and Ant B, per card. Each I and Q component is assumed to be 8 bits (1 byte), with no bit interleaving. The number of adjacent samples in a serial packet from the same antenna is 2, and the repetition is 2. Each packet from each RF card will contain 8 samples, including 4 samples from antenna A and 4 samples from antenna B. The incoming packets to the PPS chip 1420 on the respective input ports 1421 may look as illustrated in FIG. 15. Some preprocessing, such as bit extension/deletion operations, will not be illustrated. FIG. 16 illustrates queues 0-7 formed for the respective channels after preprocessing.

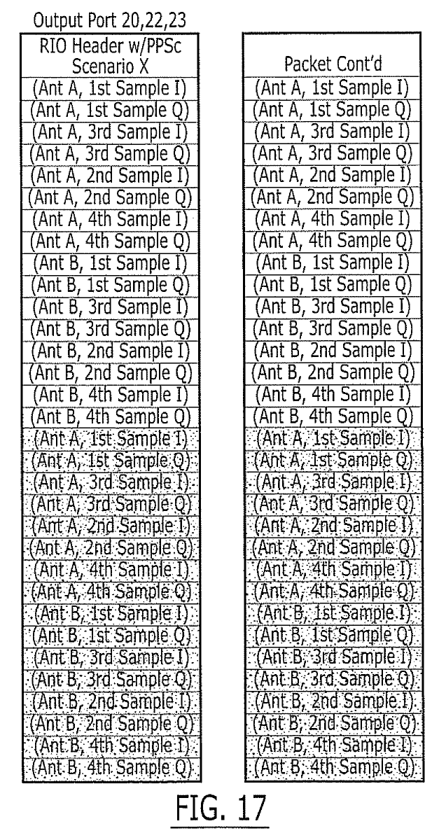

A first example of packet processing according to some embodiments of the present invention is illustrated in FIG. 17. A single packet is synthesized from all of the queues 1-7, with no summing of the samples. The synthesized packet is sent to output ports 20, 22, and 23, addressed to a specific memory address in a target device.

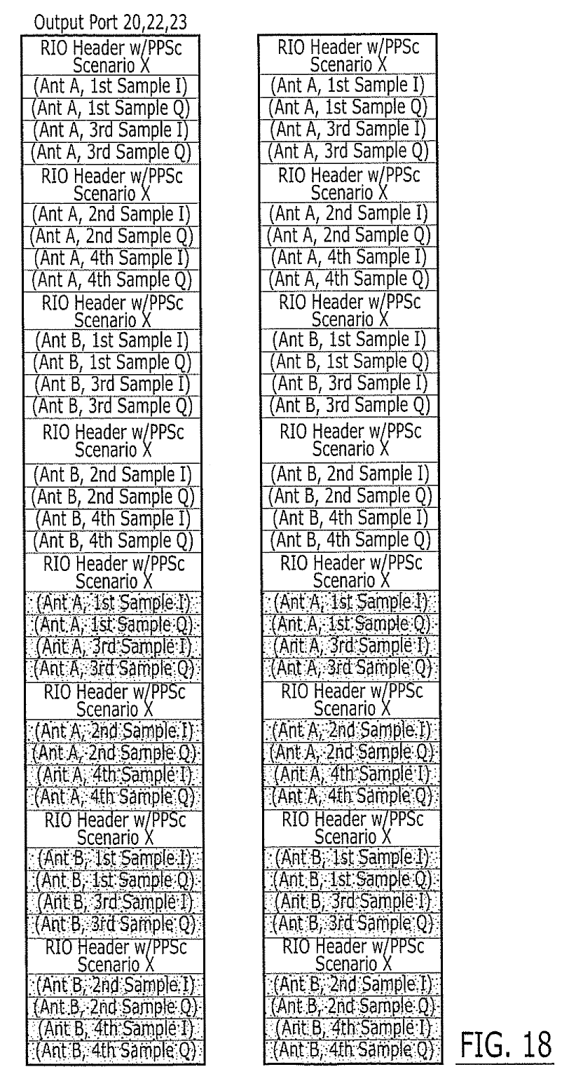

A second example of packet processing according to further embodiments of the present invention is illustrated in FIG. 18. Multiple synthesized packets are generated from the queues 0-7 illustrated in FIG. 16, with each synthesized packet including 4 samples from each queue. All of the synthesized packets are sent to output ports 20, 22, and 23, and each is addressed to a respective memory address of a target device.

In some applications, a user may want to send different packets to different destination groups. To do this, the user may send the packet to a group packet processing scenario address using an addressing scheme along the lines described above with reference to FIG. 7. This results in parallel operation of multiple packet processing scenarios, with each input packet being received by each of the multiple scenarios. The scenarios can independently process the packets, and generate different packets and send them to different ports.

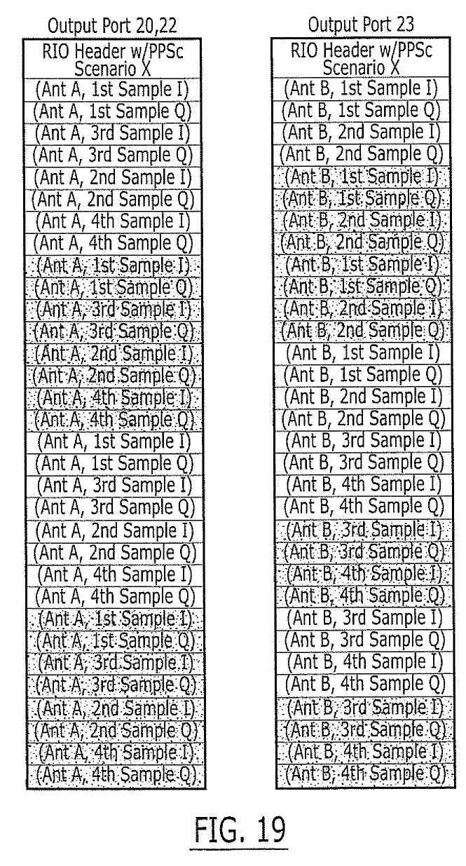

An example of such multiple-packet to multiple-destination packet processing according to further embodiments of the present invention is illustrated in FIG. 19. The user sends a packet destined to a group packet processing scenario, which maps to two individual packet processing scenarios. The first scenario takes inputs from queues 0, 2, 4 and 6. The packet produced by the first scenario is sent to output polls 20, 22. The second scenario takes inputs from queues 1, 3, 5, and 7. The packet produced by the second scenario is sent to output port 23.

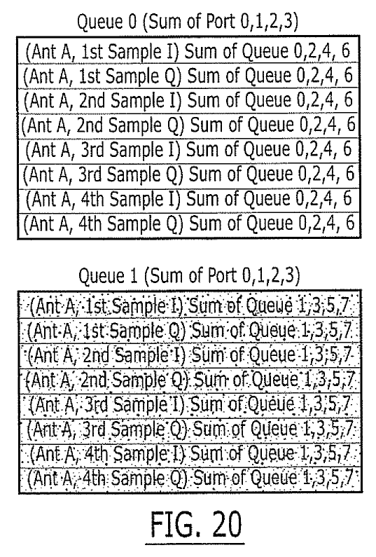

FIG. 20 shows an example wherein summing is enabled. When summing is enabled, respective channels are summed and new queues are formed. The resulting synthesized packet is sent to output ports 20, 22 and 23).

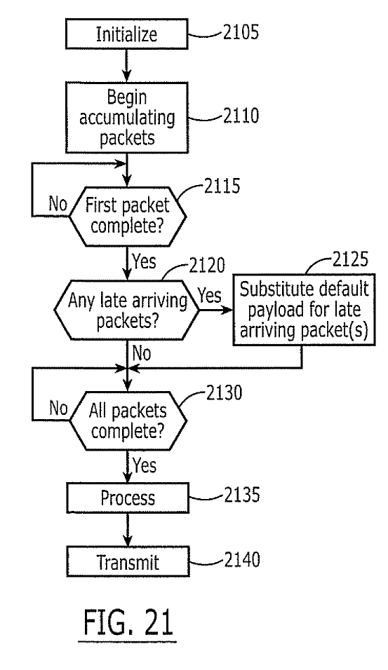

Referring again to FIG. 1, packets that are received at any of the input ports 110 of a packet processing switch IC chip 100 may be packets (e.g., signal sample packets) that require processing in the packet processor 120 or packets that are to be forwarded by the switching fabric 130 without payload modification. In addition, packets for different packet processing scenarios 132 may be multiplexed at any of the input ports. It is generally desired that operations of the packet processor 130 be synchronized to maintain desired data rates and to meet other timing criteria. Exemplary operations for synchronizing packet processing operations will now be described with reference to FIGS. 21-26.

According to some embodiments of the present invention, a packet processor operates using a dynamic packet accumulation approach. Once all incoming packets needed to complete a particular scenario have been accumulated at the device, they are processed to form one or more output packets associated with the scenario. The output packet(s) is then transmitted out of the output port(s) associated with the scenario. In some embodiments, each packet processing scenario processes one input packet per port per processing interval, with all input packets being used by a particular scenario running at substantially the same data rate and having the same size and format.

In some embodiments, dynamic packet accumulation may be implemented using a state machine that transitions responsive to accumulation and processing events. Each scenario may be configured (e.g., via configuration registers, such as the configuration registers 250 in FIG. 2) with knowledge of the input ports that will be providing packets. Referring to FIG. 21, after initialization of the state machine (block 2105), packets for a scenario begin accumulating (block 2110). In the illustrated embodiments, it is required that all packets destined for the scenario start accumulating within the accumulation time for a first arriving packet; the payload for any packet arriving after the first packet has completed accumulation is replaced with a default payload (blocks 2115, 2120, 2125). After all packets that meet the requirement to start accumulation in the accumulation window defined by the accumulation time of the first-arriving packet have completed accumulation, the packets (i.e., the accumulated packet and, in some cases, any replacement packets) are processed to generate one or more output packets (blocks 2130, 2135), which are then transmitted (block 2140). A new accumulation period (block 2110) may commence after processing of the previously received packets begins.

A packet processing scenario may be initialized, for example, by a write to an initialization register or some other initialization signal. A succeeding received packet associated with the packet processing scenario (e.g., a packet addressed to the scenario's address) may then be considered as the first packet into the scenario.

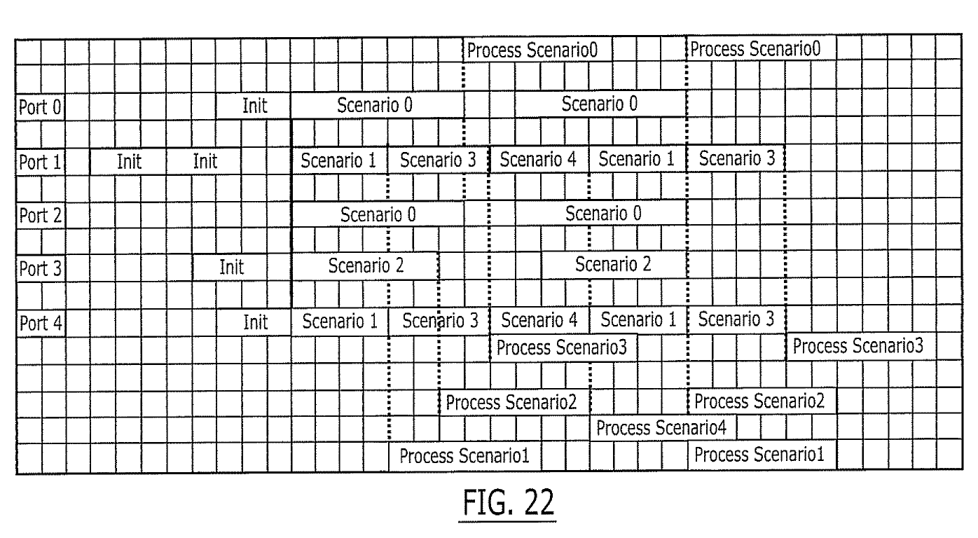

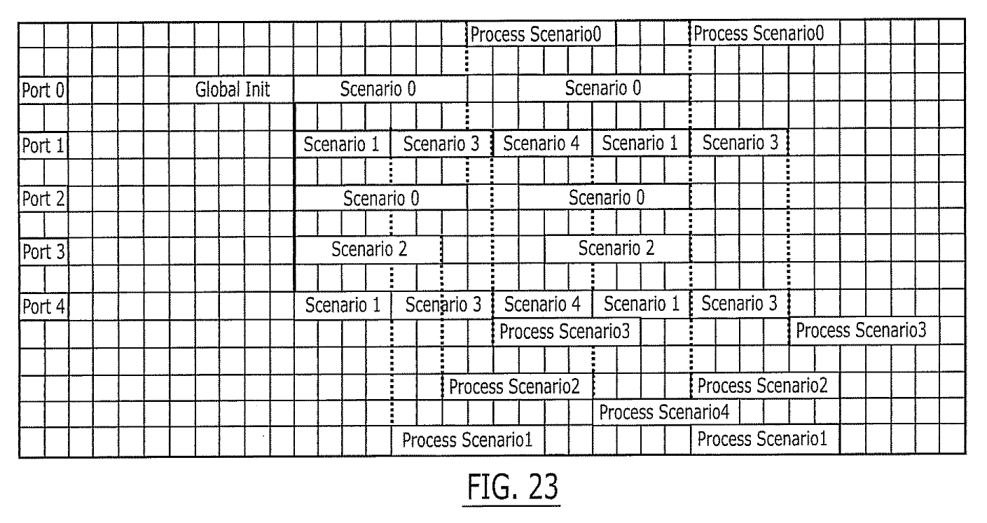

FIG. 22 illustrates Scenarios 0-4, which can be synchronized independent of one another by sending respective initiation signals Init1-Init4. If an initialization signal is sent to a group packet processing scenario along the lines described above with reference to FIG. 7, all related individual packet processing scenarios may be initialized. If an input port is used for more than one scenario, the initialization signals for the multiple scenarios may be received on the same port or on separate ports. After receipt of its initialization signal, a packet processing scenario begins accumulating packets (as shown in the shaded areas), followed by processing of the accumulated packets to synthesize new packets. As shown in FIG. 22, accumulation of packets for any given scenario begins with the start of accumulation of a first-arriving packet for the scenario. Generally, scenarios do not have to start at the same time. In further embodiments, a “global” initialization may be achieved, for example, by writing to a global initialization register and/or by simultaneously providing initialization signals to all packet processing scenarios, as shown in FIG. 23. A global initialization signal may come via any port.

Different scenarios may have different latencies associated with the size and packet processing needed. Generally, processing time is dependant on the amount of data sent to a scenario (size of packet and number of incoming ports), and the type of calculation (sample manipulation, addition, etc.).

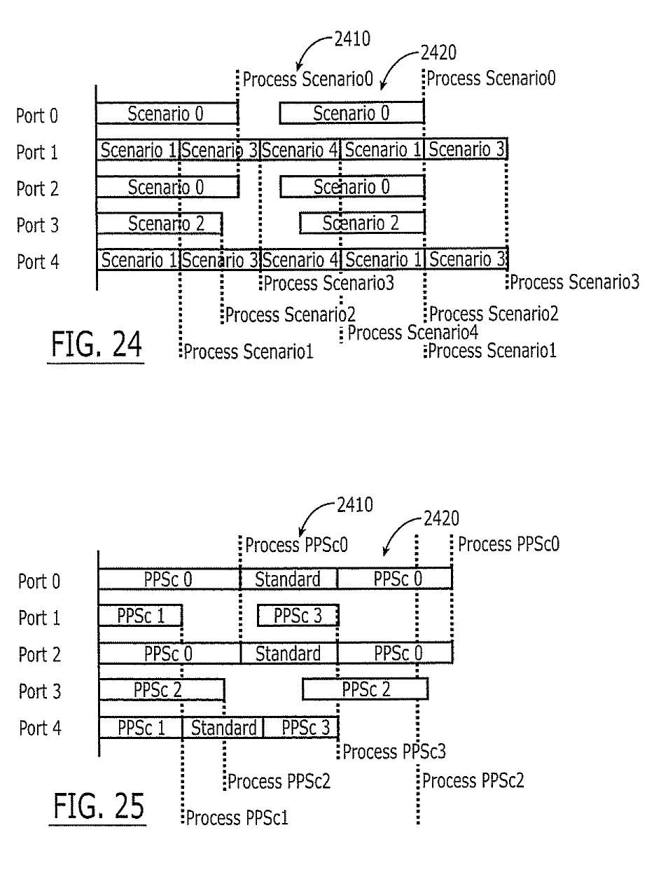

FIG. 24 shows an example in which 5 scenarios 0-4 are in operation. Scenario 0 has space between the arrival of first and second packets on ports 0 and 2, illustrating that processing time may dictate how often a packet can be sent to a given scenario from a given port. In particular, processing 2410 for a first iteration of Scenario 0 may occur concurrent with accumulation of packets for a succeeding second iteration 2420 of Scenario 0. Scenario 2 is similar to Scenario 0, except that Scenario 2 has a smaller packet size and a longer processing time, which means that packets for Scenario 2 are sent at lower rate than for Scenario 0. Port 1 and port 4 receive packets destined for multiple Scenarios 1, 3 and 4, illustrating that a port may be more efficiently used by “hiding” the processing time for a particular scenario by sending a packet for a different scenario during the processing interval. By multiplexing packets for multiple scenarios on Port 1 and Port 4, throughput may be increased.

The dynamic packet accumulation described above can provide significant flexibility in system synchronization. According to some embodiments of the present invention, packet processing scenarios wait for the first packet to arrive to begin the accumulation phase on a per scenario basis. This allows for initialization of the packet processor before bringing up the transmitters connected to the device, because each scenario begins operating after it begins receiving packets.

If a “standard” packet that is not intended for payload processing (e.g., a packet that is to be routed by a switching fabric, such as the switching fabric 130 of FIG, 1) is sent to a port that is also receiving packets that require payload processing, the standard packet may be received during idle time (e.g., processing time) of the port. This is illustrated in FIG. 25, where standard packets are multiplexed with packets intended for packet processing scenarios PPSc1-3. If no ports have sufficient idle time to “fit” a standard packet, then the user could dedicate ports for packets to be payload-processed and separate ports for standard packets.

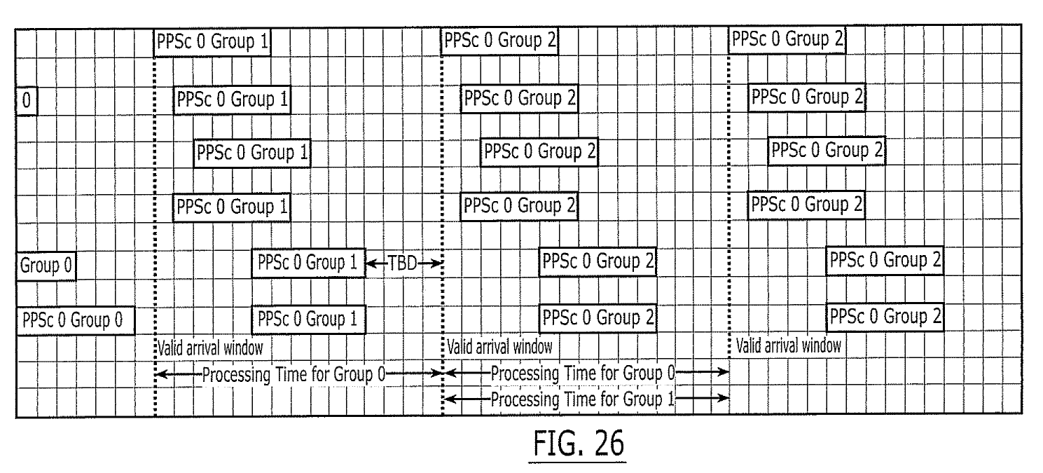

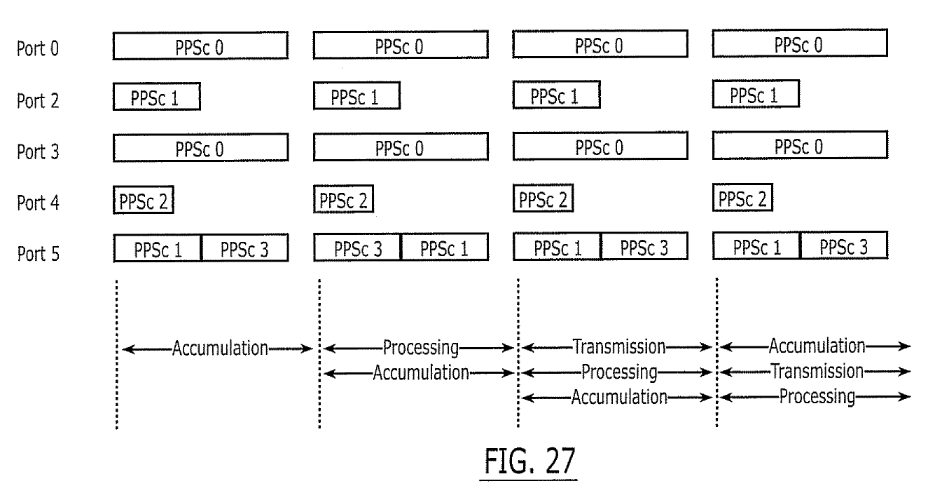

Accumulation of packets may be limited to an accumulation window defined by arrival of a first packet. This requirement can tie the valid arrival window for packets going to the same scenario to the data rate of the links, as illustrated in FIG. 26. As shown, a packet of a group PPSc 0 Group 0 on Port 2 arrives first and dictates the valid arrival window for all other packets destined for the same scenario PPSc0. As shown, a packet from the same group on Port 5 is late, arriving after the packet on Port 2 has accumulated. The packet on Port 5 may be ignored, e.g., a value of all zeros (or some other value) may be used in its place during processing. A next accumulation window is started with the arrival of a first packet of a group PPSc 0 Group 1 after all previous valid Group 0 packets have finished processing. As described above, the arrival time of the next group of packets into the packet processor may be dictated by the processing time of the previous group.

In further embodiments of the present invention, a time-division multiplexed (TDM) mode of operation may be achieved by sending packets at times dictated by the longest processing time of all the operative scenarios in the packet processor. Referring to FIG. 27, arrival times of all packets for packet processing scenarios PPSc 0-3 can be controlled such that the windows 2710 shown in FIG. 27 are wide enough to support tile longest processing time of all the scenarios. The packet processor may be configured to control transmission of outgoing packets from the scenarios PPSc 0-3 to make the device appear to be operating in a TDM mode. In particular, the device may initiate transmission of outgoing packets with the start of accumulation of a next incoming group of packets after processing of the outgoing packets has completed.

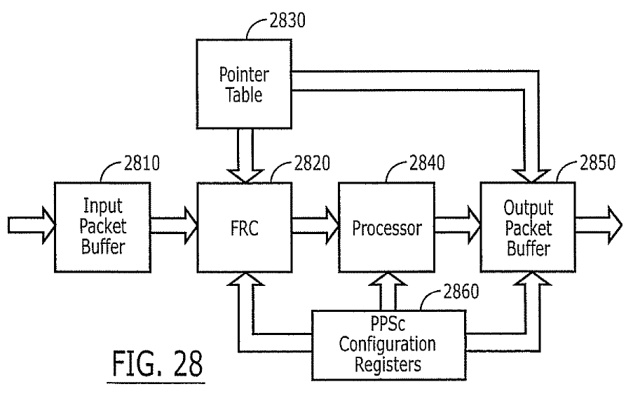

FIG. 28 illustrates an alternative configuration for a packet processor 2800 (e.g., a packet processor for use in a packet processing switch, such as the packet processing switch 100 of FIG. 1) according to further embodiments of the present invention. The packet processor 2800 includes an input packet buffer 2810 configured to store incoming packets. A FIFO Read Controller (FRC) 2820 reads data (e.g., signal samples from payloads of received messages) from the input packet buffer 2810 as specified by a pointer table 2830. The pointer table 2830 relates input data locations in the input packet buffer 2810 to output data locations in an output packet buffer 2850. A processor 2840 performs sample manipulation as specified by information stored in packet processing scenario (PPSc) configuration registers 2860. Processed data output by the processor 2840 is written into the output packet buffer 2850, which constructs output packets therefrom.

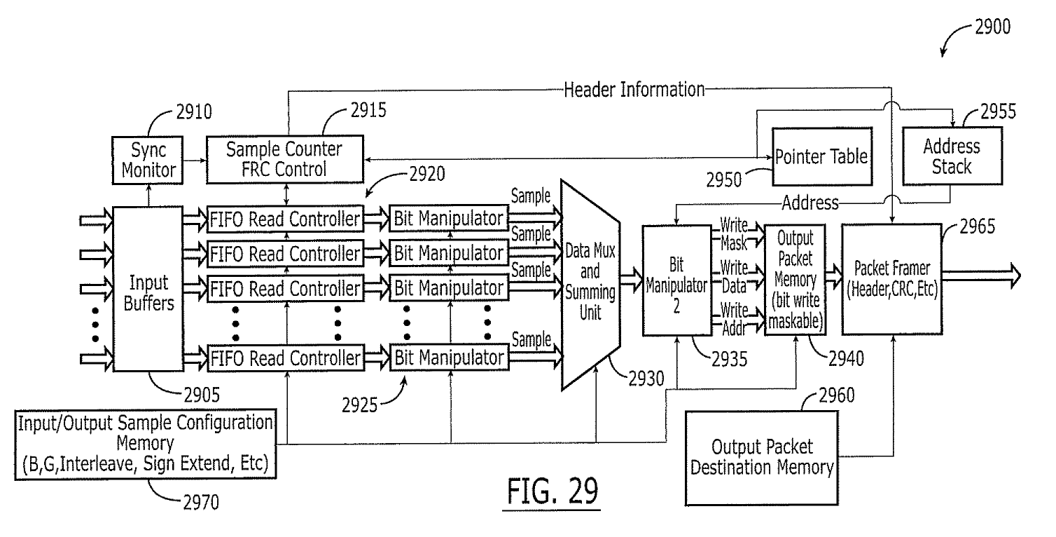

FIG. 29 illustrates an exemplary configuration for a packet processor along the lines described above with reference to FIG. 28 according to further embodiments of the present invention. A packet processor 2900 includes input buffers 2905 that are configured to receive packets from a plurality of ports (not shown). A synchronization monitor module 2910 monitors the timing of the incoming packets and extracts header information therefrom via FRCs 2920 that access packets stored in the input buffers 2905. The extracted header information is provided to a packet framer 2965 for use in constructing output packets including payload information generated by processing payload information in the input packets received by the input buffers 2905.

The FRCs 2920 access packets stored in the input buffers 2905 responsive to control signals generated by a sample counter and FRC control unit 2915. The sample counter and FRC control unit 2915 generates the control signals responsive to error and control information generated by the synchronization monitor module 2910, address information from a pointer table 2950, and packet processing scenario control information from configuration registers of an input/output sample configuration memory 2970. The FRCs 2920 transfer payload data from the input buffers 2905 to a set of first bit manipulators 2925, which perform de-interleaving, sign extension and/or bit deletion operations as specified by packet processing scenario control information stored in the input/output sample configuration memory 2970.

A data mux and summing unit 2930 performs summation operations as specified by packet processing scenario control information stored in the input/output sample configuration memory 2970, and may further perform dynamic/saturation ranging of the summation outputs. The output of the data mux and summing unit 2930 is provided to a bit manipulator 2935, which performs flipping (e.g., MSB/LSB), IQ ordering and/or IQ interleaving operations as specified by packet processing scenario control information stored in the input/output sample configuration memory 2970. The bit manipulator 2935 provides the processed data, along with an address and mask, to an output packet memory 2940. Data is transferred from the output packet memory 2940 to the packet framer 2965, which constructs new packets using header information from the sample counter and FRC control unit 2915 and an output packet destination memory 2960.

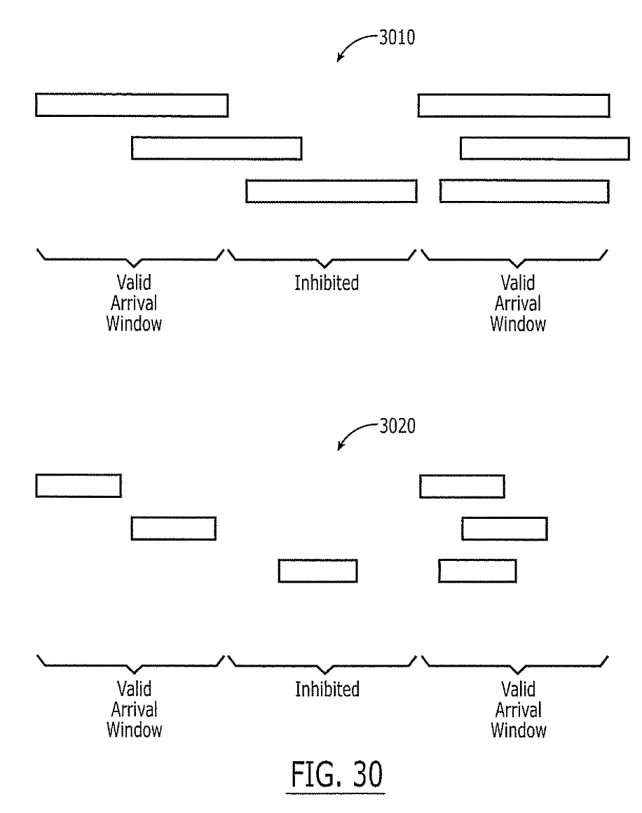

As discussed above with reference to FIG. 26, accumulation of packets may be limited to an accumulation window defined by complete arrival of a first packet, such that a valid arrival window for packets going to the same scenario is dependent on the bit rate of the links. According to other embodiments of the present invention, a packet processor may use a fixed packet accumulation window with a duration that is independent of the bit rate for the packets. Thus, as shown in FIG. 30, packets 3010, 3020 transferred at respective first and second bit rates may receive the same processing irrespective of the different bit rates at which they are accumulated. Packets arriving outside of such a valid accumulation window may be processed along lines similar to those described above with reference to FIG. 26, e.g., such packets may be ignored and replaced by predetermined packets. The use of such an approach, however, could lead to processing overload due to too many packets arriving in a given window. According to further embodiments of the present invention, this may be avoided by inhibiting initiation of a new valid arrival window for a predetermined time interval after closing of the preceding valid arrival window, as also shown in FIG. 30. It will be understood that this time interval may be fixed or user-configurable (e.g., programmable). Other alternative implementations may involve defining valid arrival windows that occur at predetermined times, i.e., windows that do not depend of arrival of a first packet to define their start, and which may be separated by intervals sufficient to prevent overload.

It will be appreciated that the packet processing switch architectures described above are illustrative examples, and that other packet processing switch architectures fall within the scope of the present invention. More generally, in the drawings and specification, there have been disclosed exemplary embodiments of the invention. Although specific terms are employed, they are used in a generic and descriptive sense only and not for purposes of limitation, the scope of the invention being defined by the following claims.

That which is claimed is:

1. A packet processing integrated circuit chip, comprising;
a plurality of input ports configured to receive packets from respective external sources;
a plurality of output ports configured to transmit packets to respective external recipients; and
a packet processor configurable to process the received packets to generate new output packets with new payloads according to selected ones of a plurality of packet processing scenarios and to convey the new output packets to the output ports, wherein timing of each packet processing scenario is controlled responsive to received packet accumulation for the packet processing scenario.

2. A chip according to claim 1, wherein the packet processor is configured to initiate packet accumulation for a packet processing scenario responsive to an initialization signal.

3. A chip according to claim 1, wherein a packet processing scenario of the plurality of packet processing scenarios comprises a set of accumulation, processing and transmission operations required to generate a given number of new output packets from a given number of received packets, and wherein the packet processor is configured to iteratively execute the packet processing scenario responsive to received packet accumulation therefor.

4. A chip according to claim 3, wherein an iteration of the packet processing scenario comprises processing of payloads of received packets for the packet processing scenario responsive to accumulation and/or generation of the given number of received packet payloads required to generate the given number of new output packets.

5. A chip according to claim 3, wherein the packet processing scenario replaces a payload of any packet addressed to the packet processing scenario that commences accumulating outside of a packet accumulation window defined by accumulation of a first accumulating received packet with a default packet payload.

6. A chip according to claim 5, wherein the packet accumulation window is terminated responsive to accumulation of the first accumulating received packet.

7. A chip according to claim 5, wherein the packet accumulation window terminates after expiration of a predetermined time interval following initial accumulation of the first accumulating received packet.

8. A chip according to claim 5, wherein initiation of a next packet accumulation window is inhibited for a time interval following termination of the packet accumulation window.

9. A chip according to claim 1, wherein the packet processor is configurable to extract data from payloads of the received packets and to process the extracted data to produce the new packets with the new payloads having formats compatible with data structures of the external recipients.

10. A chip according to claim 1, further comprising a packet switching fabric configured to route selected packets from the input ports to selected ones of the output ports.

11. A chip according to claim 1, wherein the packet processor selectively applies the packet processing scenarios based on destination addresses in the packets.

12. A chip according to claim 1, wherein the plurality of packet processing scenarios comprises individual packet processing scenarios and group packet processing scenarios that invoke concurrent processing by selected ones of the individual packet processing scenarios.

13. A chip according to claim 1, wherein the packet processing scenarios are user-configurable.

14. A chip according to claim 1, wherein the packet processor is configurable to perform bit extension, bit truncation, bit reordering and/or bit arithmetic operations on the received packets.

15. A chip according to claim 1, further comprising an inter-integrated circuit (I²C) bus interface, and wherein the packet processor, the input ports and/or the output ports are configurable via the I²C bus interface.

16. A chip according to claim 1, wherein the received packets and the new packets are RapidIO™ (RIO)-compliant packets.

17. An interface circuit for conveying data between a first plurality of circuit cards and a second plurality of circuit cards, the interface circuit comprising
a plurality of input ports configured to receive packets from respective ones of the first plurality of circuit cards;
a plurality of output ports configured to transmit packets to respective ones of the second plurality of circuit cards; and
a packet processor configurable to process the received packets to generate new output packets with new payloads according to selected ones of a plurality of packet processing scenarios and to convey the new output packets to the output ports, wherein timing of each packet processing scenario is controlled responsive to received packet accumulation for the packet processing scenario.

18. An interface circuit according to claim 17, wherein the packet processor is configured to initiate packet accumulation for a packet processing scenario responsive to an initialization signal.

19. An interface circuit according to claim 17, wherein a packet processing scenario of the plurality of packet processing scenarios comprises a set of accumulation, processing and transmission operations required to generate a given number of new output packets from a given number of received packets, and wherein the packet processor is configured to iteratively execute the packet processing scenario responsive to received packet accumulation therefor.

20. An interface circuit according to claim 19, wherein an iteration of the packet processing scenario comprises processing of payloads of received packets for the packet processing scenario responsive to accumulation and/or generation of the given number of received packet payloads required to generate the given number of new output packets.

21. An interface circuit according to claim 19, wherein the packet processing scenario replaces a payload of any packet addressed to the packet processing scenario that commences accumulating outside of a packet accumulation window defined by accumulation of a first accumulating received packet with a default packet payload.

22. An interface circuit according to claim 21, wherein the packet processor is configured to terminate the packet accumulation window responsive to completion of accumulation of the first accumulating received packet.

23. An interface circuit according to claim 21, wherein the packet processor is configured to terminate the packet accumulation window responsive to expiration of a predetermined time interval following initial accumulation of the first accumulating received packet.

24. An interface circuit according to claim 21, wherein the packet processor is configured to inhibit initiation of a next packet accumulation window for a time interval following termination of the packet accumulation window.

25. An interface circuit according to claim 17, wherein the packet processor is configurable to extract data from payloads of the received packets and to process the extracted data to produce the new packets with the new payloads having formats compatible with data strictures of processors of the second plurality of circuit cards.

26. An interface circuit according to claim 17, further comprising a packet switching fabric configured to route selected packets from the input ports to selected ones of the output ports.

27. An interface circuit according to claim 17:
wherein the plurality of input ports are configured to receive packets from respective ones of a plurality of RF cards; and
wherein the plurality of output ports are configured to transmit packets to respective ones of a plurality of baseband cards.
